(19) United States
(12) Patent Application Publication
(10) Pub. No.: US 2006/0042160 A1
(43) Pub. Date: Mar. 2, 2006

(54) Tomato stake

(76) Inventor: Paul Lipkin, Lafayette Hill, PA (US)

Correspondence Address: RATNERPRESTIA, P O BOX 980, VALLEY FORGE, PA, 19482-0980, US

(21) Appl. No.: 10/929,964

(22) Filed: Aug. 30, 2004

(51) Int. Cl. A01G 17/14

(52) U.S. Cl. 47/47

(57) ABSTRACT

A tomato stake is provided. The tomato stake includes an elongated insertion member having an insertion end and an exposed end having an outer diameter and an elongated tubular member having an inner diameter being larger than the outer diameter. The tubular member is disposed over the exposed end. The tubular member may optionally include a plurality of support pins extending therefrom. A method of installing the tomato stake is also provided.

### FIELD OF THE INVENTION

The present invention relates to a stake used to support tomato or other plants.

### BACKGROUND OF THE INVENTION

Tomato stakes are used to support a tomato plant as the plant is growing. Tomato plants tend to grow fairly large, with some tomato plants growing at least as high as 2 meters (approximately 6 feet) into the air. Tomato growers tie the plants to stakes to prevent the weight of the plants from snapping the plant stems and ruining the plants, to prevent high winds from blowing the plants over, and to prevent plant fruit from weighing down their respective branches and engaging the ground, thus promoting fruit rot.

In past tomato stakes, which consist solely of an elongated pole inserted into the ground next to the plant, difficulties have been encountered with both the installation and the use of the stakes. Due to the potential growth size of tomato plants, the traditional tomato stake is normally taller than the average person. This length makes the stake cumbersome to install, particularly for a person of relatively small stature, the elderly, and the disabled. One option for such a person is to climb a ladder to pound the stake into the ground, creating a potentially unsafe environment by putting a ladder on uneven ground, leading the installer to risk falling off the ladder while pounding the stake into the ground.

In attempts to solve some of these problems, inventions have been provided in which multiple pieces are put together to form the stake. For example, U.S. Pat. No. 5,279,073 to Czebieniak, discloses an arrangement of pieces wherein a hollow top piece inserts into a hollow lower piece which is either at or below ground level. However, one obvious drawback is the potential for the introduction of dirt and debris inside the lower piece, which would inhibit the connection of the two pieces altogether and defeat the purpose of the stake.

Also lacking in other tomato stakes is the presence of a device to securely fasten to the plant and keep the device from sliding up and down the plant stem in natural movement, thus causing damage to the plant stem.

It would therefore be beneficial to provide a plant stake that is easily as well as safely installed.

### BRIEF SUMMARY OF THE INVENTION

Briefly, the present invention provides a tomato stake. The tomato stake comprises an elongated insertion member having an insertion end and an exposed end having an outer diameter and an elongated tubular member having an inner diameter being larger than the outer diameter. The tubular member is disposed over the exposed end.

The present invention also provides a method of installing a tomato stake. The method comprises inserting an insertion end of an insertion member into ground, allowing there to be an exposed end; and disposing a tubular member over the exposed end of the insertion member.

The present invention also provides a tomato stake comprising an elongated insertion member having an insertion end and an exposed end having an outer diameter, and an elongated tubular member having an inner diameter being larger than the outer diameter. The tubular member is disposed over the exposed end. A plurality of support pins extends generally transversely from the tubular member.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a tomato stake in accordance with a first embodiment of the present invention;

FIG. 2 is a sectional view of the tomato stake taken along lines II-II;

FIG. 3 is an enlarged perspective view of a first embodiment of an insertion member of the tomato stake of FIG. 1;

FIG. 4 is an enlarged perspective view of a second embodiment of the insertion member;

FIG. 5 is an enlarged perspective view of a third embodiment of the insertion member;

FIG. 6 is a sectional view of the tomato stake taken at lines VI-VI of FIG. 1; and

FIG. 7 is a sectional view of an alternative cross sectional shape of the tomato stake.

### DETAILED DESCRIPTION OF THE INVENTION

In the drawings, like numerals indicate like elements throughout. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

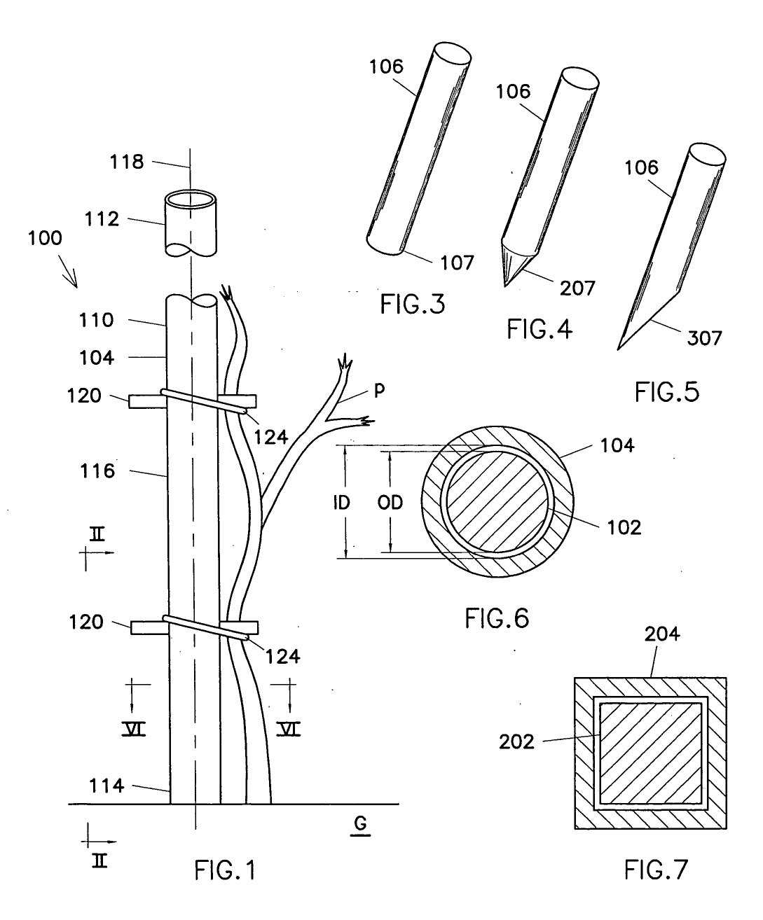

Referring to, FIG. 1, a tomato stake 100 according to the present invention is shown. The stake 100 is used to support a tomato plant “P” as the tomato plant P grows. Although the stake 100 is preferably for use with tomato plants, those skilled in the art will recognize that the stake 100 may be used for other plants that require staking, such as pepper plants, etc.

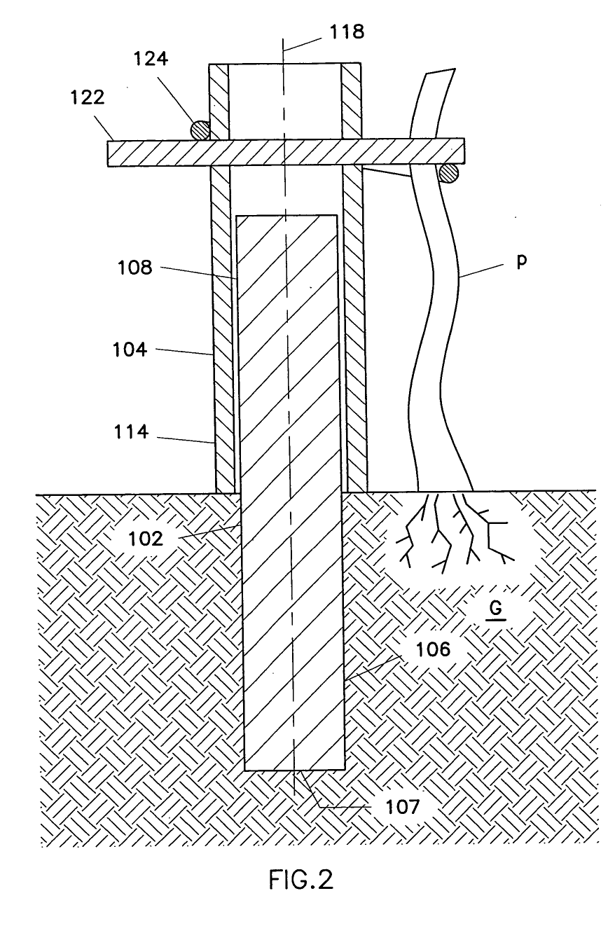

The stake 100 includes an insertion member 102, shown in the sectional view of FIG. 2, as well as an elongated tubular member 104. The tubular member 104 is disposed over the insertion member 102 such that the insertion member 102 supports the tubular member 104 in a vertical orientation relative to the ground “G”.

The insertion member 102 includes an insertion end 106 and an exposed end 108 and a preferably cylindrical body 110. The insertion member 102 is preferably constructed from steel, such as for manufacturing rebar, although those skilled in the art will recognize that the insertion member 102 may be constructed of any suitable metallic material or any other material of similar strength. Typically, the insertion member 102 is between the lengths of approximately 0.5 to 1 meter (approximately 1½ to 3 feet), but those skilled in the art will recognize that the insertion member may be less than 0.5 meter or more than 1 meter in length. The shape of the insertion member 102 is also preferably cylindrical but may also be rectangular, triangular, or any other suitable shape, as long as the tubular member 104 is able to be disposed over the exposed end 108 of the insertion member 102.

In one embodiment, the insertion end 106 includes a flat tip 107, such as is shown in the enlarged perspective view of the insertion end 106 of FIG. 3. However, those skilled in the art will recognize that the insertion end 106 may include a pointed tip, such as the tips 207, 307, shown in FIGS. 4 and 5, respectively. The tip 207 is sharply tapered off of the edges of the insertion member 102 to form a point, as to pierce the surface of the ground G more easily in harder ground conditions. The tip 307, shown in FIG. 5, is also sharply tapered, however not to the same extent as the tip 207 shown in FIG. 4. Instead of forming one sharp point from being tapered evenly off of the edges of the insertion member 102, the tip 307 forms a flat surface from a lower point on the insertion member 108 to a higher point of the insertion member 108. The tips 107, 207, 307 are only three potential embodiments for the end of the insertion member 102 and those skilled in the art will recognize that design of the tip of the insertion member 102 design is not restricted to only those embodiments. Such pointed tips 207, 307 will assist in inserting the insertion member 102 into the ground G, as will be discussed in detail later herein.

Referring back to FIG. 1, the elongated tubular member 104 includes a top end 112 and a bottom end 114. A generally tubular body 116 extends between the top end 112 and the bottom end 114. A longitudinal axis 118 extends along the body 116 between the top end 112 and the bottom end 114. The top end 112 may be closed, or alternatively may be open, but the bottom end 114 must be open in order to allow the tubular member 104 to be disposed over the insertion member 102.

Preferably, the body 116 is approximately 2 meters (approximately 6 feet) in length, although those skilled in the art will recognize that the body 116 may be more or less than 2 meters. Although not shown, the body 116 may be constructed from a plurality of members that are able to be connected to each other to form a desired length.

The tubular member 104 is preferably made of a light metal, such as aluminum, or a polymer, such as polyvinyl chloride, but any other suitable material of similar strength, length and rigidity may be used. Alternatively, the tubular member 104 may be constructed of wood or a composite material. However, for ease of manufacturing, a preferred material is one that may be extruded or molded.

Preferably, the body 116 has a cylindrical cross section, such as is shown in FIG. 6, although other shapes may alternatively be used, so long as the bottom end 114 of the tubular member 104 is able to be disposed over the exposed end 108 of the insertion member 102 during use. For example, an alternative cross section for each of an insertion member 202 and a tubular member 204 are shown in FIG. 7.

The inner diameter “ID” of the tubular member 104 is just slightly larger than that of the outer diameter “OD” of the exposed end 108 of the insertion member 102, as seen in FIG. 6. For example, for an inner diameter of the tubular member 104 being approximately 1.2 cm (0.5 inches), the outer diameter of the exposed end 108 of the insertion member 102 is preferably approximately 1.0 cm (0.4 inches), although those skilled in the art will recognize that both the ID and the OD may be other values. An interference fit between the ID and the OD is not desired, as such a fit would make it difficult to insert the tubular member 104 over the insertion member 102 and to remove the tubular member 104 from the insertion member 102 after using the stake 100.

Referring back to FIGS. 1 and 2, a plurality of support pins 120 extend from the body 116, generally transversely to the longitudinal axis 118. However, those skilled in the art will recognize that the support pins 120 may extend from the body 116 at an acute angle from the longitudinal axis 118. While only two pins 120 are shown in FIG. 1, those skilled in the art will recognize that preferably more than two pins 120 are used. However, it is conceivable that even only one or no pins 120 may be used. The pins 120 are preferably spaced approximately 20 cm apart, although those skilled in the art will recognize that the pins 120 may be spaced more or less than 20 cm apart. If the top end 112 of the tubular member 104 is open, as discussed above, the support pins 120 may be symmetrically spaced along the length of the tubular member 104 such that the tubular member 104 may be disposed over the insertion member 102 “upside down” so that the top end 112 becomes, in effect, the bottom of the tubular member 104 and is inserted directly over the insertion member 102.

Preferably, each support pin 120 extends outwardly from the body 116 approximately 2.5 cm (approximately 1 inch). Support pins 120 may be disposed 180 degrees apart from each other around the body 116 of the tubular member, as is shown in FIG. 1, or the support pins may be disposed less than 180 degrees apart from each other. For support pins 120 that are disposed 180 degrees apart from each other, a single pin member 122 may be inserted completely through the interior of the body 116 and extend exteriorly from the body 116 in two opposing directions, such as is shown in FIG. 2. The support pins 120 and the alternative pin member 122 may have a generally cylindrical cross section, although those skilled in the art will recognize that the support pins 120 and the pin member 122 may have other cross sectional shapes as well.

The support pins 120 may be inserted into the body 116 after manufacture of the body 116, such as by drilling or otherwise forming a hole in the body 116 and inserting each support pin 120 therein. Alternatively, if the single pin member 122 as described immediately above is used, two opposing holes may be formed in the body 116, with the pin member 122 inserted through both holes and extending from either side of the body 116. Alternatively, if the tubular member 104 is manufactured by molding, the support pins 120 may be molded directly onto the body 116. The support pins 120 or the pin member 122 are preferably constructed from the same material as the body 116, although those skilled in the art will recognize that the pins 120 and the pin member 122 may be constructed from other materials, as well.

Since the stake 100 is intended to be used to support vegetation, it is preferred that the tubular member 104 has an earth tone color, such as green or brown, in order to blend in with the vegetation and not be easily visible. Such an earth tone color may be sprayed on or otherwise applied to the exterior of the tubular member 104 after manufacturing. Alternatively, particularly if the tubular member 104 is constructed from a polymer, an earth tone pigment may be applied to the polymer material prior to manufacturing the tubular member 104, so that the earth tone color extends completely through the tubular member 104. Still alternatively, the tubular member 104 may not have coloring added at all.

To use the stake 100, the insertion member 102 is inserted into the ground G, with the insertion end 106 inserted into the ground G and the exposed end 108 extending above the ground G, as shown in FIG. 2. If the tip of the insertion end 106 is a tapered tip 207, 307, as described above and is shown in FIGS. 4 and 5, the insertion member 102 will likely be inserted into the ground G much more easily than if the flat tip 107 shown in FIG. 3 is used. Preferably, the insertion member 102 is pounded into the ground G with a hammer or mallet. However, if the insertion member 102 with either pointed tip 207, 307 is used, and is the ground G is sufficiently soft, it may be possible to insert the insertion member 102 without the need for a hammer or mallet.

The insertion member 102 is inserted into the ground approximately half way, or enough so that the insertion member 102 is securely embedded in the ground G and will be able to support the tubular member 104. In this manner, the exposed end 108 extends above the ground G.

The bottom end 114 of the tubular member 104 is disposed over the exposed end 108 so that the tubular member 104 extends upward from the ground G, as is shown in FIG. 1. The plant P may be planted before or after inserting the stake 100.

The plant P, as it grows, is then tied to the stake 100 through the use of securing devices 124, such as string, ties, or other known securing devices. The securing devices 124 are preferably tied around both the plant P and the support pins 120 so that the securing devices do not slide down the body 116 of the tubular member 104.

At the end of the growing season, or after the plant P dies, plant P is cut away from the stake 100 and removed. The tubular member 104 is lifted from the insertion member 102 and stored away until the next season. The insertion member 102 may be removed from the ground G and stored with the tubular member 104, or, alternatively, the insertion member 102 may remain in the ground G. If so, for the next growing season, the tubular member 104 need only be disposed over the insertion member 102 and the stake 100 is installed and ready to be tied to a new plant P.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A tomato stake comprising:
an elongated insertion member having an insertion portion and an exposed portion having an outer diameter, wherein the insertion portion and the exposed portion make up the entire length of the elongated insertion member; and
an elongated tubular member having an inner diameter being larger than the outer diameter, wherein the tubular member is adapted to be disposed over the entire exposed portion.

2. The tomato stake claimed in claim 1, wherein the insertion portion is cylindrical.

3. The tomato stake claimed in claim 1, wherein the insertion portion comprises an insertion end being sharply tapered.

4. The tomato stake claimed in claim 1, wherein the tubular member is comprised of a polymer material.

5. The tomato stake claimed in claim 1, wherein the tubular member is comprised of a metallic material.

6. The tomato stake claimed in claim 1, wherein the tubular member further comprises a plurality of support pins extending transversely therefrom.

7. The tomato stake claimed in claim 1, wherein the tubular member is of an earth tone color.

8. The tomato stake claimed in claim 1, wherein the tubular member is manufactured by extrusion.

9. The tomato stake as claimed in claim 1, wherein the tubular member is manufactured by molding.

10-12. (canceled)

13. A tomato stake comprising:
an elongated insertion member having an insertion portion and an exposed portion having an outer diameter, wherein the insertion portion and the exposed portion make up the entire length of the elongated insertion member;
an elongated tubular member having an inner diameter being larger than the outer diameter, wherein the tubular member is adapted to be disposed over the entire exposed portion; and
a plurality of support pins extending generally transversely from the tubular member.

14. The tomato stake claimed in claim 13, wherein the insertion portion is cylindrical.

15. The tomato stake claimed in claim 13, wherein the insertion portion comprises an insertion end being sharply tapered.

16. The tomato stake claimed in claim 13, wherein the tubular member is comprised of a polymer material.

17. The tomato stake claimed in claim 13, wherein the tubular member is comprised of a metallic material.

18. The tomato stake claimed in claim 13, wherein the tubular member is of an earth tone color.

19. The tomato stake claimed in claim 13, wherein the tubular member is manufactured by extrusion.

20. The tomato stake as claimed in claim 13, wherein the tubular member is manufactured by molding.
